(19) United States
(12) Patent Application Publication
(10) Pub. No.: US 2023/0175614 A1
(43) Pub. Date: Jun. 8, 2023

(54) THERMOPLASTIC HOSE, AND A DEVICE AND A METHOD FOR PRODUCING SUCH A HOSE

(71) Applicant: HC-KUNSTSTOFFWERK RÜLZHEIM GMBH, Rülzheim (DE)

(72) Inventors: Fabian SCHWARZ, Neuburg am Rhein (DE); Hardy WEISENBURGER, Neuburg am Rhein (DE); Thomas BECKER, Rohrbach (DE); Andreas HAMBURGER, Rülzheim (DE)

(21) Appl. No.: 17/911,069

(22) PCT Filed: Mar. 11, 2021
(86) PCT No.: PCT/EP2021/056168

§ 371 Date: Sep. 12, 2022

(30) Foreign Application Priority Data
Mar. 12, 2020 (DE) 10 2020 106 777.1

(51) Int. Cl. F16L 11/08; B29C 48/12; B29C 48/21; B29C 48/33; F16L 11/11; B29C 48/10

(52) U.S. Cl. CPC F16L 11/081; B29C 48/12; B29C 48/21; B29C 48/33; F16L 11/11; B29C 48/10; B29C 2791/001

(57) ABSTRACT

The present invention relates to a thermoplastic hose, consisting of a flexible hose body (12; 212; 312; 612) and at least one reinforcing element (14; 214; 314; 614), which is arranged helically on the external face of the hose body (12; 212; 312; 612), wherein the at least one reinforcing element (14; 214; 314; 614) is made of an extruded material and is rigidly joined to the external face of the hose body (12; 212; 312; 612) by means of a fusion bond, wherein the hose body (12; 212; 312; 612) is an extruded hose body (12; 212; 312; 612). The invention also relates to a device and a method for producing such a hose.

### TECHNICAL FIELD

The present invention relates to a hose having at least one reinforcing element and to a device and to a method for producing such a hose.

### PRIOR ART

Hoses are used in a large number of different fields of application. Since the hoses are generally flexible, i.e., bendable, they have the advantage over rigid pipes that they can be adapted to external conditions comparatively easily. In contrast to pipes, hoses can be easily routed along curved or twisted points. However, the advantage of flexibility in spatial arrangement has the disadvantage that a hose can be kinked or squeezed so that the inner diameter of the hose is narrowed. In extreme cases, this can result in a complete blockage of the hose.

One of the many fields of application for hoses is vehicle construction. In vehicle construction, for example, water hoses are used to drain rainwater from body parts such as the sunroof or tank cap to the ground. These hoses are usually inserted manually in the nearly completed vehicle. Due to the limited space available in the vehicle, these hoses have to be routed along narrow and curved paths. There is a risk here that the hose will end up in a crushed position or even be kinked during installation. A crushed or kinked hose will result in water not draining off the body properly. The result can be water stains or water damage inside the vehicle.

There is therefore a need for hoses that, on the one hand, are very flexible and, on the other hand, exhibit a high level of security against accidental kinking or crushing.

It is known that a flexible hose, which has a reinforcing strip attached helically to the external face of the hose body, has a higher kink resistance than a hose without such a reinforcing strip.

The production method of such hoses is sometimes very complex or can usually only be implemented at low production speeds. For example, in a method described in EP 1 719 939 B1, an inner hose is coiled from a strip of material onto a hose former, with a reinforcing strip then being applied laterally onto the hose body that rotates during the coiling process.

As a rule, in this type of hose production, the material strip for the hose body is coiled with an overlap, so that the hose body is thicker than the material strip at the seams. This causes the inner wall of the hose body to be uneven. In some cases, indentations can even form in the inner wall of the hose body. If liquid medium, such as water, is fed through the hose, the indentations form spaces in which the liquid medium can collect. From a hygienic point of view, this can be problematic since, for example, using water as the liquid medium, bacteria can form in the water remaining in the indentations.

In addition, there is the risk that potential fracture points of the hose will occur at the seams of the hose body and the hose will have leaks.

Thus, although the hoses made according to the method described in EP 1 719 939 B1 are suitable for air to flow through, these hoses are only suitable to a limited extent for water to flow through.

### PRESENTATION OF THE INVENTION

It is the object of the present invention to provide a flexible hose that has a comparatively high kink resistance, can be produced more cost-effectively and more quickly than previously known hoses, and is particularly suitable for use as a water hose.

The object is achieved by a hose according to claim 1 and by a device and by a method for producing such a hose according to claims 10 and 14.

The hose according to the invention comprises a flexible hose body and at least one reinforcing element which is arranged helically on the external face of the hose body, wherein the at least one reinforcing element is made of an extruded material and is rigidly joined to the external face of the hose body by means of a fusion bond, and wherein the hose body is an extruded hose body.

The use of an extruded hose body instead of a hose coiled from one or more strips of material has the advantage that the hose can be produced much more cost-effectively and quickly. In addition, the extruded hose has no seams or joints like a coiled hose, so that there are no potential breakage points. The extruded reinforcing element, which is applied onto the hose body directly from an extrusion unit, i.e., in the melted state, forms a firm and stable fusion bond with the hose body.

The invention is preferably based on an extruded hose that is produced by means of a stationary forming tool and discharged linearly or in a straight line. This is a linearly extruded hose. Alternatively, the hose can be produced by means of a rotating mold, so that the hose rotates about its axis after exiting the extruder. In this case, it is a rotating extruded hose.

In a preferred embodiment, the inner wall of the hose body is smooth. Using extrusion methods for producing the extruded hose body, it is not only possible to obtain a hose body without seams or bumps, but also to obtain a smooth inner wall in the hose body. This hose is therefore also suitable for use as a water hose in applications with high hygienic requirements. This type of hose is particularly suitable for water hoses in which, for example, drinking water is transported, since there are no dead spaces inside the hose in which the water could collect. A particularly smooth inner wall of the hose body is achieved in particular when the extruded hose is a linearly extruded hose.

A smooth surface is understood in this case to be a surface that has no visible or noticeable unevenness. In particular, it is a surface that does not impede the flow of a fluid through the hose line.

In order to obtain a uniformly stable hose, the extruded inner hose preferably has a target inner diameter which, in the longitudinal direction of the hose body, exhibits fluctuations in relation to the target diameter which are less than 5%, preferably less than 3%.

It is preferable that the inner wall of the hose body has a corrugation of an irregular wavelength and/or having a long-wave wave in the longitudinal direction of the hose. This means that the flow rate along the hose is as uniform as possible.

In the hoses, which are made of a coiled material, bumps occur at regular intervals and at short wavelengths at the connecting seams. This can result in a multitude of undesirable dead spaces and weak points in the hose. Even in the case of rotating extruded hoses, short-wave unevenness can be seen in the hose wall. In the case of extruded hoses, which are only discharged linearly without rotating the extruded hose, the fluctuations in the target inner diameter only occur as long-wave and generally irregular fluctuations.

In the field of hoses, such as water hoses, short wavelengths are in the range of the diameter of a hose, while long wavelengths exhibit lengths that are many times the diameter of a hose, namely at least 5 times, in particular up to 10 times, sometimes even up to 100 times. For example, for coiled water hoses having diameters of 0.2 cm to 10 cm, the wavelengths of the fluctuations of the inner diameter are typically in the centimeter range of about 0.2 cm to 10 cm, while, for linearly extruded hoses, the wavelengths of the fluctuations of the inner diameter are more than 20 cm, typically more than 50 cm, sometimes even more than 1 m.

In a preferred embodiment, in the case where the inner wall of the hose body has a corrugation having elevations and indentations in the longitudinal direction of the hose, the distance between two adjacent indentations of the hose is greater than the pitch of two coils of the reinforcing element, preferably even greater than the pitch of five coils of the reinforcing element. In this way, a comparatively uniform reinforcing of the hose over the length can be achieved since the influence of the fluctuation in thickness of the hose over the length is minimized. As noted above, the distance between adjacent indentations is very large in an extruded hose that has only been discharged linearly without rotation of the extruded hose. In these hoses, the reinforcing element can therefore be applied onto the hose either with a very small or a large distance between the individual coils, since no or only very small combination effects of the reinforcing elements with the fluctuation in thickness of the hose have to be taken into account. This means a high degree of flexibility when choosing a suitable type of reinforcing for a hose by means of a reinforcing element. In the case of linearly extruded hoses, significantly more than five coils can be applied between two adjacent indentations. It is not uncommon to place more than 50 coils between two adjacent indentations.

It is advantageous that the at least one reinforcing element has at least one strip-like or thread-like helical element. A strip-like or thread-like helical element is understood in this case to be both a flat strip of any desired cross-sectional shape and a thread of any desired cross-sectional shape. The cross-sectional shapes can, for example, be round, oval, polygonal, or curved in any way. In addition, a cross-sectional shape can have round and angular portions. The reinforcing elements can be designed as a hollow profile in cross section. However, it is preferable for the reinforcing elements to be a full-area or solid construction in cross section.

In a preferred embodiment, the at least one reinforcing element has at least two helical elements that are arranged at a distance from one another and are each arranged helically on the external face of the hose body. This has the advantage, for example, that the production speed of a hose can be increased since the at least two reinforcing elements can be applied onto the extruded hose at the same time or almost at the same time. In addition, this makes it possible for at least two helical elements to be arranged in a cross-sectional plane of the hose, so that the kink resistance of the hose can be significantly improved as a result.

In this embodiment, it is of particular advantage that the at least two helical elements that are arranged at a distance from one another are aligned parallel to one another, so that the coils of each helical element have the same inclination. This ensures that the helical elements do not overlap, even in the case of long hoses.

The at least two helical elements arranged at a distance from one another can have the same properties. In an alternative embodiment, the properties of the individual helical elements can differ. For example, the two helical elements can differ in their cross-sectional shape, so that the hose has at least two different helical elements.

It is further preferred that the at least one reinforcing element has a higher rigidity than the hose body. The rigidity can be influenced by the number of coils per length of hose. The more coils that are provided per length of hose, the stiffer the hose becomes. Additionally or alternatively, the reinforcing element itself can have a higher rigidity than the hose body. This can be done, for example, by selecting a suitable material for the reinforcing element or by selecting the size and cross-sectional shape of the reinforcing element.

Considering that the at least one reinforcing element and the flexible hose body constitute two components, it is advantageous that the adhesive strength between the flexible hose body and the at least one reinforcing element is at least 20% of the tensile strength of the weakest component. A particularly high adhesive strength is achieved in particular in that the extruded reinforcing element, which is applied onto the hose body directly from an extrusion unit, i.e., in the melted state, hits the hose body that has just been produced and has not yet completely cooled.

To protect the flexible hose, a cover layer is provided in a preferred embodiment, which is provided on the external face of the hose body and covers the hose body and the at least one reinforcing element at least in portions. The cover layer is preferably an extruded material. The cover layer can, for example, be an extruded hose or be formed from an extruded strip-like material that is coiled around the hose body with the reinforcing element.

Thermoplastic materials, in particular extrudable thermoplastic materials such as PVC, TPE, or PP, are suitable for producing the hose body described and the at least one reinforcing body. These materials can also be used for the cover layer.

The subject matter of the present invention is also a device for producing a hose according to the invention, the device comprising a system unit that can be operated in a continuous process. The system unit comprises in this case a first extrusion unit for producing a hose body and a second extrusion unit for producing a reinforcing element, wherein the second extrusion unit is arranged behind the first extrusion unit in the discharge direction of the hose and has a nozzle rotating about the hose body.

Within the scope of the invention, an extrusion unit is understood to be a unit which comprises an extruder having an extruder screw and a forming tool. In this case, a nozzle is the forming tool itself or part of the forming tool.

In the first extrusion unit, in particular a stationary, in the sense of non-rotating, forming tool is provided, so that the hose body can be discharged linearly and a linear, i.e., non-rotated or non-rotating, hose body is formed. For example, a hose nozzle can be provided as the forming tool.

Using a nozzle that rotates about the hose body, it is possible to apply a helical reinforcing element onto the hose moving in the production or discharge direction in a continuous process. The reinforcing element can be applied onto the hose at a variety of different angles. The number of coils per hose length can be adjusted as desired and, in contrast to rotating hoses and a stationary forming tool for the reinforcing element, is not dependent on the hose's rotational speed.

It is particularly preferred in this case that the second extrusion unit has a stationary extruder and a rotating forming tool having a nozzle or a forming tool having a rotating nozzle. In this way, a comparatively inexpensive design of the device can be achieved.

In order to apply a cover layer onto the hose, it is advantageous that a third extrusion unit is provided, which is arranged behind the second extrusion unit in the discharge direction of the hose, the third extrusion unit preferably comprising a hose nozzle or a wide slot nozzle. The third extrusion unit can be part of the system unit with the first and second extrusion units or part of an additional system unit that is separate from the system unit having the first and second extrusion units.

In a preferred embodiment, a heating device is provided, which is arranged behind the third extrusion unit in the discharge direction of the hose. This embodiment is particularly advantageous when the third extrusion unit comprises a wide slot nozzle and the cover layer is coiled around the hose with the at least one reinforcing element. The cover layer can be securely fastened to the hose body using the at least one reinforcing element with the aid of the heating system.

It goes without saying, however, that a heating device can also be provided when using a third extrusion unit with a hose nozzle, in which a hose element is made, in order, for example, to securely connect the composite of hose body, reinforcing element, and cover layer by means of a fusion bond.

A method for producing a hose as described comprises the following steps:

First, the hose body is extruded, with the hose body being extruded in such a way that it does not rotate about its longitudinal axis. Furthermore, at least one strip-like or thread-like reinforcing element is extruded, which is applied helically onto the hose body in the melted state. In the context of the present invention, the melted state, in contrast to the solidified state, is understood to be that state which the material exhibits when it emerges from the extrusion unit and is therefore still plastically deformable. The method is characterized in that the extruded hose body is discharged linearly and is fed in a straight line to the second extruder. The hose emerging from the first extruder does not rotate about its axis. The strip-like or thread-like reinforcing element is helically applied onto the hose discharged from the extruder by coiling the reinforcing element around the hose moving in a straight line.

In a preferred embodiment, the steps of extruding the hose body, extruding the at least one strip or thread-like reinforcing element, and helically applying the reinforcing element onto the hose body take place in a continuous process, so that the strip-like or thread-like reinforcing element can be applied onto the not yet completely cooled hose body that comes out of the extrusion unit.

It goes without saying that, in the methods described, the application of a cover layer can also be provided.

### BRIEF DESCRIPTION OF THE DRAWINGS

Preferred embodiments are explained in more detail with reference to the accompanying drawings, in which:

FIG. 1a-d are a first embodiment of a hose,

FIG. 2 is a scheme showing the method for producing a hose,

FIG. 3a-d are a second embodiment of a hose,

FIG. 4a-d are a third embodiment of a hose,

FIG. 5 is a cross section through a helical thread according to a first alternative embodiment,

FIG. 6 is a cross section through a helical thread according to a second alternative embodiment, and

FIG. 7a-c are a fourth embodiment of a hose.

Ways to carry out the invention and industrial applicability:

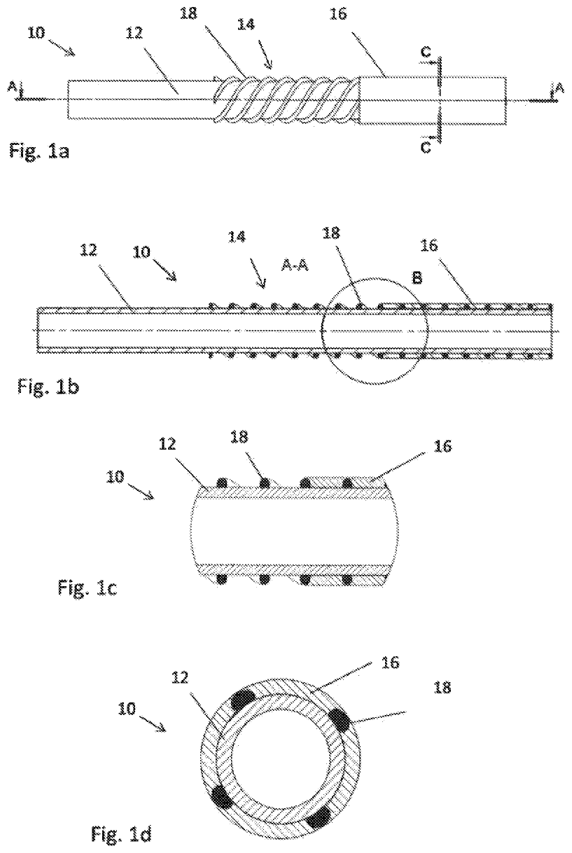

In FIG. 1a to 1d, a hose 10 is shown according to a first embodiment.

FIG. 1a is a side view of the different layers of the hose 10. FIGS. 1b and 1c each show a longitudinal section through the hose 10. FIG. 1d shows a cross section through a hose.

The hose 10 comprises a flexible hose body 12, a helical reinforcing element 14, and a cover layer 16. The diameter of the hose 10 ranges from 2 mm to 70 mm.

The hose body 12 is an extruded hose body 12 having a predetermined first rigidity. The inner wall and the outer wall of the hose body 12 are smooth and have no seams or joints.

The hose 10 and in particular the hose body 12 each have a predetermined target inner diameter, with the fluctuations in the inner diameter of the hose body 12 compared to the target diameter in the longitudinal direction of the hose body 12 being less than 5%, preferably less than 3%. Due to the extrusion, these are long-wave fluctuations in the target inner diameter in the longitudinal direction of the hose body. The wavelength of the fluctuations in the target inner diameter is many times larger than the pitch of the coils of the helical reinforcing element 12. While the wavelengths of the fluctuations in the target inner diameter are around 0.5 m to 1.5 m, the pitch of the coils is in the range of around 1 mm to 100 mm.

The helical reinforcing element 14 consists of four helical threads 18 arranged parallel to one another, the coils of which have a predetermined inclination with respect to the longitudinal axis of the hose 10. The helical reinforcing elements 14 are materially connected to the extruded hose body 12. In particular, the helical threads 18 are connected to the hose body 12 by means of a fusion bond.

The four helical threads 18 arranged parallel to one another are each arranged at the same distance from one another, so that, as can be seen in FIG. 1d, the helical threads 18 are positioned equidistantly along the circumference of the hose body 12 on the external face of the hose body 12.

The cross section of each helical thread 18 has an oval basic shape (see FIG. 1c), the helical thread 18 being adapted to the geometry of the hose body 12 at the contact surface with the hose body 12. The helical thread 18 is an extruded, solid helical thread 18.

The helical reinforcing element 14 has a predetermined second rigidity.

The rigidity of the reinforcing element 14 is greater than the rigidity of the hose body 12. The rigidity of the reinforcing element 14 is a parameter with the aid of which the kink rigidity or kink resistance of the finished hose 10 can be influenced.

The cover layer 16 is an extruded hose element, the helical threads 18 being embedded in the cover layer 16. The cover layer 16 has a predetermined third rigidity. The cover layer 16 is connected to the hose body 12 and the reinforcing element by means of a material bond, in particular by means of a fusion bond. The cover layer 16 has a rigidity that is at least less than the rigidity of the helical thread 18.

The hose body 12, the reinforcing element 14, and the cover layer 16 are made of thermoplastic materials such as TPE, PP, or PVC.

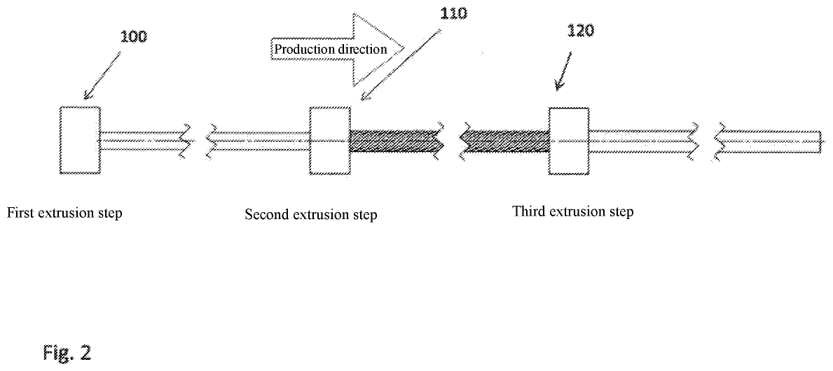

FIG. 2 shows the basic method steps for producing a hose, such as the hose 10 shown in FIGS. 1a to 1d.

First of all, the hose body 12 is made in a first extrusion step 100 by means of a first extrusion unit. For this purpose, a hose nozzle is used as a forming tool, so that the hose body can be discharged in a straight line, i.e., without rotating about its own axis, in the discharge direction. The hose body 12 is then cooled in a known manner using a water bath. In a second extrusion step 110, the reinforcing element 14 is applied onto the still warm or not completely cooled hose body 12 using a second extrusion unit. For this purpose, the thermoplastic material of the reinforcing element 14 is melted in the second extrusion unit and, while still in the melted state, reaches the hose body 12 as a thread-like or strip-like material moving in the production direction or discharge direction. In order to achieve a helical coil of the reinforcing element 18 on the hose body 12 that does not rotate about its axis, the second extrusion unit comprises a rotating nozzle that rotates about the hose body 12.

In a third extrusion step 120, the hose body 12 around which a reinforcing element 14 is coiled reaches a third extrusion unit. This third extrusion unit applies a cover layer 16 onto the hose body 12 and the reinforcing element 14. The hose emerging from the third extrusion unit is pre-assembled, i.e., cut at the required points.

In the method shown in FIG. 2, the three extrusion steps 100, 110, 120 take place continuously in a system for producing a hose. In other words, there is no type of assembly between the individual extrusion steps 100, 110, 120 in which the hose 10 is severed.

The system for implementing the method shown in FIG. 2 comprises three extrusion units, each extrusion unit having an extruder having an extruder screw and a forming tool.

In detail, the system for implementing the method shown in FIG. 2 comprises a first extrusion unit having a nozzle for producing a hose-shaped element, namely a nozzle for producing the hose body, a conveying section, preferably with water cooling, a second extrusion unit, a further conveying section, and a third extrusion unit.

The second extrusion unit for producing the reinforcing element comprises a stationary extruder and a rotating nozzle, wherein either the nozzle itself rotates about the hose body or the forming tool in which the nozzle is installed rotates about the hose body. The third extrusion unit is an extrusion unit for producing a hose-shaped element. In this case, the hose body provided with the reinforcing element extends through the third extrusion unit.

As indicated above, in the second extrusion step, an extrusion unit is provided which has a rotating nozzle. The nozzle can have one or more outlets. In the hose shown in FIG. 1a to 1d, a four-outlet nozzle was used to produce the four helical strips arranged parallel to one another.

After the third extrusion unit in the third extrusion step, a further conveying section can also be provided, which leads to an assembling unit, in particular to a separating device. Optionally, a heating device can also be provided after the third extrusion unit and before the assembling unit, in order to form, for example, an improved fusion bond between the cover layer and the hose body provided with the reinforcing element.

In an embodiment (not shown) of the method for producing hoses, it is provided that only the first and second extrusion steps 100, 110 take place continuously.

The corresponding system thus comprises only a first extrusion unit having a nozzle for producing a hose-shaped element such as the hose body, a conveyor line, preferably having water cooling, a second extrusion unit, and preferably a further conveying section, which leads, for example, to an assembling unit, in particular to a separating device.

This method is particularly suitable for the production of hoses that do not require a cover layer. However, it does not exclude the application of a cover layer.

In a device corresponding to this method, the third extrusion unit, which provides the preassembled hose body with a cover layer, is located in an additional system separate from the system having the first and second extrusion unit.

In one embodiment, the third extrusion unit in the separate system can be an extrusion unit that extrudes a hose-shaped element and applies it onto the preassembled hose body. Alternatively, the extrusion unit can comprise a wide slot nozzle and produce a strip of material that is coiled onto the preassembled hose body rotating about the longitudinal axis. In both cases, after the application of the cover layer, a thermal method step can be provided, by means of which the cover layer is connected to the hose body and the reinforcing element by means of a fusion bond.

The materials should preferably be selected in such a way that, due to the fusion bond, there is a high adhesive strength between the hose body and the reinforcing element and/or the cover layer. If the selected materials do not achieve this adhesive strength, a step for applying an adhesion promoter can be provided both before the second extrusion step 110 and before the third extrusion step 120.

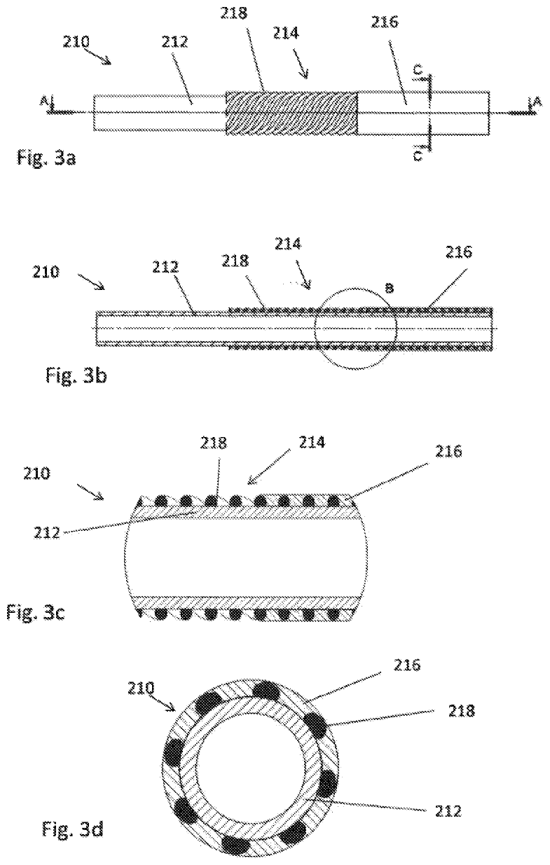

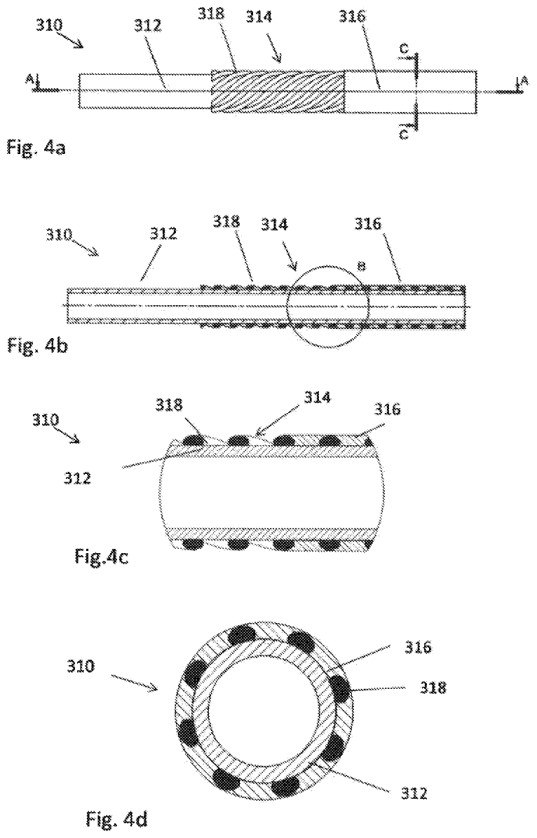

FIGS. 3a to 3d and 4a to 4d respectively show a second and third embodiment of a hose 210; 310.

In particular, FIGS. 3a to 3d and 4a to 4d show two different hoses 210; 310 that have eight helical threads 218; 318 instead of four helical threads 18 arranged next to one another shown in the embodiment in FIGS. 1a to 1d.

The structure of the hose body 212; 312 and the cover layer 216; 316 and the production of the hose 210; 310 do not differ in the embodiments shown in FIGS. 3a to 3d and 4a to 4d from the embodiment shown in FIGS. 1a to 1d.

The hoses 210; 310 shown in FIGS. 3a to 3d and 4a to 4d thus have eight helical threads 218; 318 that are arranged equidistantly in a cross-sectional plane around the outer circumference of the hose body 212 or 312. The kink resistance of the hoses shown in FIGS. 3a to 3d and 4a to 4d is therefore higher than in the hose 10 shown in FIGS. 1a to 1d due to the higher number of helical threads in a cross-sectional plane.

The hoses 210; 310 shown in FIGS. 3a to 3d and 4a to 4d differ in each case by the angle of inclination of the helical threads 218; 318 on the hose body 212; 312.

The distance and inclination of the helical threads 218; 318 can be adjusted via the process parameters such as the extraction or rotation speed of the rotating nozzle.

The distance and inclination of the helical threads 18; 218; 318 have an influence on the kink resistance or kink resistance of the finished hose 10; 210; 310.

The geometry of the cross section of the helical threads 18; 218; 318 can be chosen arbitrarily by means of the geometry of the nozzle of the forming tool. Helical threads 18; 218; 318 can thus be provided with a round or square cross section. In addition, the cross section can exhibit both rounded and angular portions.

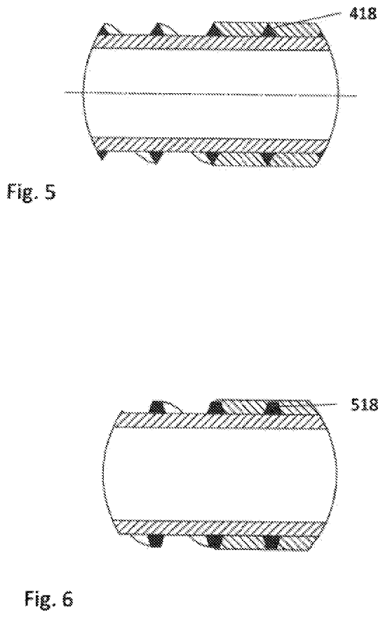

FIGS. 5 and 6 show two different geometries of a cross section of a helical thread by way of example.

The cross section of a helical thread 418 shown in FIG. 5 is triangular. The cross section of the helical thread 518 shown in FIG. 6 is trapezoidal. Otherwise, the hoses shown in FIGS. 5 and 6 do not differ from the hoses 10; 210; 310 previously shown.

In summary, the flexibility and kink resistance required by the hose 10; 210; 310 can be adjusted by a suitable selection of the rigidity of the individual components such as hose body 12; 212; 312, reinforcing element 14; 214; 314, and cover layer 16; 216; 316.

The flexibility of the hose body 12; 212; 312 and the flexibility of the cover layer 16; 216; 316 can be adjusted primarily through the choice of material and the determination of the wall thickness of the hose body 12; 212; 312 or the cover layer 16; 216; 316. The thicker the wall thickness of the hose body 112; 212; 312 or the cover layer 16; 216; 316, the stiffer the hose will be.

The rigidity of the reinforcing element 114; 214; 314 can also be influenced by the choice of material. In addition, the rigidity of the reinforcing element 14; 214; 314 can be set via the number of helical threads, the size and cross-sectional shape of the helical thread, the distance between the helical threads, and the inclination relative to the longitudinal axis of the hose.

Within the scope of the invention, the reinforcing element can have one or more helical threads. A plurality of helical threads can have the same distance between each other. However, the distance between more than two helical threads can also vary.

If more than one helical thread is provided, these helical threads can all have the same properties. In an alternative embodiment, the properties of the helical thread, such as mechanical and/or geometric properties, may differ.

Instead of a thread-like helical element, the use of strip-like helical elements is also provided within the scope of the invention.

The thermoplastic materials specified above, such as PVC, TPE, or PP, are suitable as the material for the hose. However, the use of other extrudable materials is also conceivable.

In the embodiment shown in FIGS. 1a to 1d, 3a to 3d and 4a to 4d, the reinforcing elements 14; 214; 314 are embedded in the cover layer 16, 216; 316.

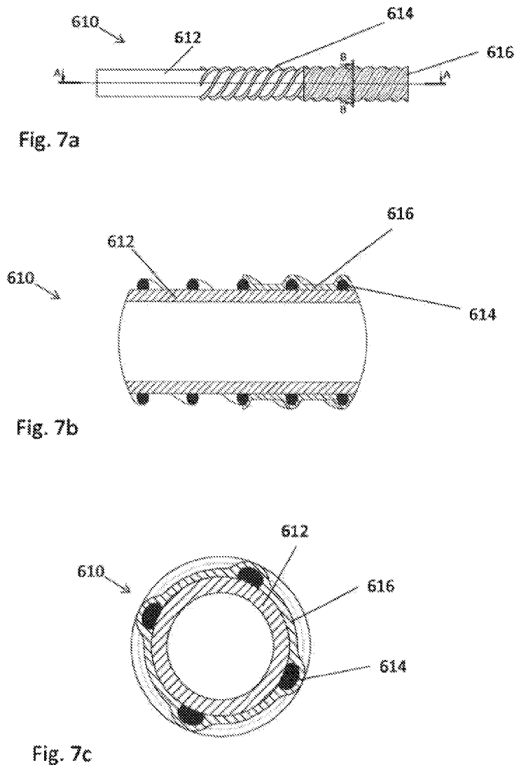

FIGS. 7a to 7c show an alternative, fourth embodiment of a hose 610.

In the hose 610 shown in FIGS. 7a to 7c, the cover layer 616 lies on the reinforcing element 614, so that the hose 610 has a corrugated profile on its external face. In this hose 610 as well, the cover layer 616 is materially bonded to the hose body 612 and the reinforcing element 614.

Although not shown, the cover layer can also be omitted from the hoses described.

The hoses described are suitable for use as water hoses. Of course, they can also be used to convey any other fluids (liquids and gases).

It goes without saying that features that have been described within the scope of one embodiment can also be combined with other embodiments.

1. Hose, comprising a flexible hose body (12; 212; 312; 612) and at least one reinforcing element (14; 214; 314; 614), which is arranged helically on the external face of the hose body (12; 212; 312; 612), wherein the at least one reinforcing element (14; 214; 314; 614) is made of an extruded material and is rigidly joined to the external face of the hose body (12; 212; 312; 612) by means of a fusion bond, characterized in that the hose body (12; 212; 312; 612) is an extruded hose body (12; 212; 312; 612).

2. Hose according to claim 1, characterized in that the inner wall of the hose body (12; 212; 312; 612) is smooth.

3. Hose according to claim 1 or 2, characterized in that the extruded inner hose has a target inner diameter which, in the longitudinal direction of the hose body, exhibits fluctuations in relation to the target diameter which are less than 5%, preferably less than 3%.

4. Hose according to any of the preceding claims, characterized in that the inner wall of the hose body has a corrugation having an irregular wavelength and/or a long-wave wave in the longitudinal direction of the hose.

5. Hose according to any of the preceding claims, characterized in that the inner wall of the hose body has a corrugation having elevations and indentations in the longitudinal direction of the hose, wherein the distance between two adjacent indentations of the hose is greater than the pitch of two coils of the reinforcing element, preferably greater than the pitch of five coils of the reinforcing element.

6. Hose according to any of the preceding claims, characterized in that the at least one reinforcing element (14; 214; 314; 614) has at least one strip-like or thread-like helical element (18; 218; 318).

7. Hose according to any of the preceding claims, characterized in that the at least one reinforcing element (14; 214; 314; 614) has at least two helical elements (18; 218; 318) that are arranged at a distance from one another and are each helically attached to the external face of the hose body (12; 212; 312; 612).

8. Hose according to any of the preceding claims, characterized in that the at least one reinforcing element (14; 214; 314; 614) has a higher rigidity than the hose body (12; 212; 312; 612).

9. Hose according to any of the preceding claims, characterized in that a cover layer (16, 216; 316; 616) is provided, which is provided on the external face of the hose body (12; 212; 312; 612) and covers the hose body and the at least one reinforcing element (14; 214; 314; 614) at least in portions.

10. Hose according to claim 9, characterized in that the cover layer (16, 216; 316; 616) is an extruded material, wherein the cover layer (16, 216; 316; 616) is preferably an extruded hose element or is made of a strip-like material.

11. Hose according to any of the preceding claims, characterized in that at least the hose body (12; 212; 312; 612) and the reinforcing element (14; 214; 314; 614) are each made of a thermoplastic material, in particular of at least one of the materials PVC, TPE, or PP.

12. Device for producing a hose (10; 210; 310; 610) according to any of the preceding claims, characterized in that the device comprises a system unit that can be operated in a continuous process, wherein the system unit has a first extrusion unit for producing a hose body (12; 212; 312; 612) and a second extrusion unit for producing at least one reinforcing element (14; 214; 314; 614), and wherein the second extrusion unit is arranged behind the first extrusion unit in the discharge direction of the hose and has a nozzle rotating about the hose body.

13. Device according to claim 12, characterized in that the second extrusion unit has a stationary extruder and a rotating forming tool having a nozzle or a forming tool having a rotating nozzle.

14. Device according to claim 12 or 13, characterized in that a third extrusion unit is provided, which is arranged behind the second extrusion unit in the discharge direction of the hose (10; 210; 310; 610), wherein the third extrusion unit preferably comprises a hose nozzle or a wide slot nozzle.

15. Device according to claim 13 or 14, characterized in that a heating device is provided, which is arranged behind the third extrusion unit in the discharge direction of the hose (10; 210; 310; 610).

16. Method for producing a hose (10; 210; 310; 610) according to any of the preceding claims, characterized by the following steps:
extruding a hose body (12; 212; 312; 612) that does not rotate about its longitudinal axis;
extruding at least one strip-like or thread-like reinforcing element (14; 214; 314; 614);
helically applying the reinforcing element (14; 214; 314; 614) in the melted state onto the hose body (12; 212; 312; 612).

17. Method according to claim 16, characterized in that the steps of extruding the hose body (12; 212; 312; 612), extruding the at least one strip-like reinforcing element (14; 214; 314; 614), and helically applying the reinforcing element (14; 214; 314; 614) onto the hose body (12; 212; 312; 612) take place in a continuous process.
